(19) United States
(12) Patent Application Publication
(10) Pub. No.: US 2022/0180188 A1
(43) Pub. Date: Jun. 9, 2022

(54) MODEL LEARNING APPARATUS, LABEL ESTIMATION APPARATUS, METHOD AND PROGRAM THEREOF

(71) Applicant: NIPPON TELEGRAPH AND TELEPHONE CORPORATION, Tokyo (JP)

(72) Inventors: Hosana KAMIYAMA, Tokyo (JP); Atsushi ANDO, Tokyo (JP); Satoshi KOBASHIKAWA, Tokyo (JP)

(73) Assignee: NIPPON TELEGRAPH AND TELEPHONE CORPORATION, Tokyo (JP)

(21) Appl. No.: 17/437,017

(22) PCT Filed: Feb. 25, 2020
(86) PCT No.: PCT/JP2020/007287

§ 371 Date: Sep. 7, 2021

(30) Foreign Application Priority Data
Mar. 6, 2019 (JP) 2019-040240

(51) Int. Cl. G06N 3/08; G06N 3/04

(52) U.S. Cl. CPC G06N 3/08; G06N 3/0472

(57) ABSTRACT

A model is learned that is capable of accurate label estimation even if learning data is used for which the number of evaluators per piece of data is small. Learning data is received that includes learning feature data and label data indicating a label given to the learning feature data by an evaluator, and based on estimation label probability values obtained by applying a label estimation model, which estimates a probability distribution of labels given to feature data, to the learning feature data serving as the feature data, and ability data, which indicates a probability that an evaluator gives a correct label to the feature data and a probability that the evaluator gives a wrong label to the feature data, an estimation observation label probability value is obtained that is a weighted sum of the estimation label probability values with the ability data, and updated ability data and an updated label estimation model are respectively obtained by updating the ability data and updating the label estimation model, the updated ability data and the updated label estimation model being updated so that an error value is reduced, the error value indicating an error of the estimation observation label probability value with respect to the label indicated by the label data.

### TECHNICAL FIELD

The present invention relates to model learning and label estimation.

### BACKGROUND ART

In tests for examining conversation skills by evaluating impression such as the likability of telephone voices (NPL 1) or the level/fluency of foreign language pronunciation (NPL 2), voices are evaluated with quantitative impression values (such as, for example, five-stage evaluation from “good” to “bad”, five-stage evaluation from “high” to “low” in terms of likability, or five-stage evaluation from “high” to “low” in terms of spontaneity).

Currently, experts in various skills evaluate the impression of a voice and give impression values, and thereby a judgement of passing or failing is made. However, if the impression of a voice can be automatically estimated and an impression value can be obtained, the value can be used as the pass mark of the test or the like, or as a reference value for experts who are inexperienced in evaluation (for example, persons who have just started working as evaluators).

In order to realize automatic estimation of a label (e.g., an impression value) for data (e.g., voice data) using machine learning, it is sufficient to perform learning processing using a pair of data and label given to the data as learning data, and generate a model for estimating a label for input data.

However, there are individual differences among evaluators, and there may be cases where an evaluator who is inexperienced in giving a label gives a label to data. Accordingly, different evaluators may give different labels to the same data.

In order to learn a model for estimating a label as obtained by averaging label values given by a plurality of evaluators, it is sufficient that a plurality of evaluators give labels to the same data, and a pair of a label obtained by averaging the values of the labels and the data is used as learning data. To enable stable estimation of an average label, it is preferable that evaluators as many as possible give labels to the same data. For example, in NPL 3, ten evaluators respectively give labels to the same data.

### CITATION LIST

### Non Patent Literature

[NPL 1] F. Burkhardt, B. Schuller, B. Weiss and F. Weninger, “Would You Buy a Car From Me?” On the Likability of Telephone Voices,” In Proc. Interspeech, pp. 1557-1560, 2011.
[NPL 2] Kei Ohta and Seiichi Nakagawa, “A statistical method of evaluating pronunciation proficiency for Japanese words,” INTERSPEECH2005, pp. 2233-2236.
[NPL 3] Takayuki KAGOMIYA, Kenji YAMASUMI, and Yohichi MAKI, “overview of impression rating data”, [online], [searched on Feb. 25, 2019]. The Internet <http://pj.ninjal.ac.jp/corpus_center/csj/manu-f/impression.pd

### SUMMARY OF THE INVENTION

### Technical Problem

Evaluators include one having a high evaluation ability and one having a low evaluation ability. In a case where there are many evaluators per piece of data, even if some of the evaluators have a low evaluation ability, the label of learning data is corrected to a label with some degree of correctness by labels given by evaluators having a high evaluation ability. However, if the number of evaluators per piece of data is small, label errors of learning data may increase due to the lack of evaluation ability of the evaluators, and a model for estimating an accurate label cannot be learned.

The present invention was made in view of the aforementioned problem, and an object thereof is to provide a technique that enables learning of a model capable of performing accurate label estimation, even if learning data is used for which the number of evaluators per piece of data is small.

### Means for Solving the Problem

Learning data is received that includes learning feature data and label data indicating a label given to the learning feature data by an evaluator, and based on estimation label probability values obtained by applying a label estimation model, which estimates a probability distribution of labels given to feature data, to the learning feature data serving as the feature data, and ability data, which indicates a probability that an evaluator gives a correct label to the feature data and a probability that the evaluator gives a wrong label to the feature data, an estimation observation label probability value is obtained that is a weighted sum of the estimation label probability values with the ability data, and updated ability data and an updated label estimation model are respectively obtained by updating the ability data and updating the label estimation model, the updated ability data and the updated label estimation model being updated so that an error value is reduced, the error value indicating an error of the estimation observation label probability value with respect to the label indicated by the label data.

### Effects of the Invention

According to the present invention, a weighted sum of estimation label probability values with ability data that indicates abilities of evaluators in probability is evaluated, and the ability data and a label estimation model are updated, thus making it possible to learn a model that is capable of performing accurate label estimation even if learning data is used for which the number of evaluators per piece of data is small.

### BRIEF DESCRIPTION OF DRAWINGS

FIG. 1 is a block diagram illustrating an example of a functional configuration of a model learning device according to a first embodiment.

FIG. 2 is a diagram illustrating an example of a configuration of learning label data.

FIG. 3 is a diagram illustrating an example of a configuration of evaluator ability data.

FIG. 4 is a diagram illustrating an example of a configuration of learning feature data.

FIG. 5 is a flow diagram illustrating a model learning method according to the first embodiment.

FIG. 6 is a block diagram illustrating an example of a functional configuration of a label estimation device according to the first embodiment and a second embodiment.

FIG. 7 is a block diagram illustrating an example of a functional configuration of a model learning device according to the second embodiment.

FIG. 8 is a diagram illustrating an example of a neural network according to the second embodiment.

FIG. 9 is a flow diagram illustrating a model learning method according to the second embodiment.

### DESCRIPTION OF EMBODIMENTS

Hereinafter, embodiments of the present invention will be described with reference to the drawings.

### First Embodiment

A first embodiment of the present invention is first described.

<Configuration>

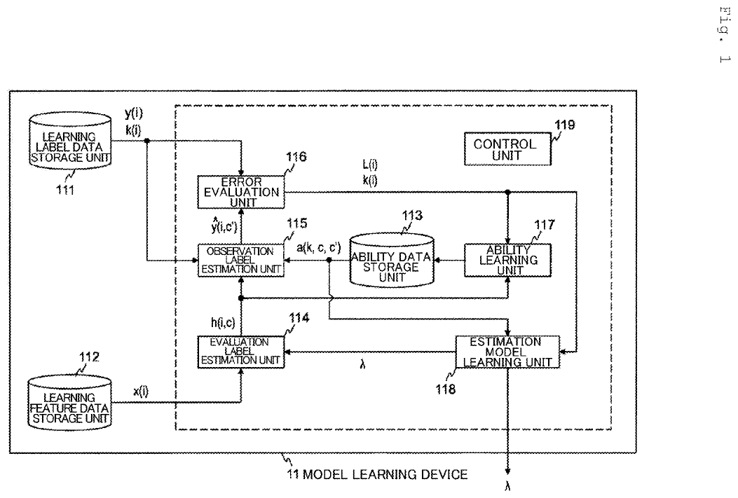

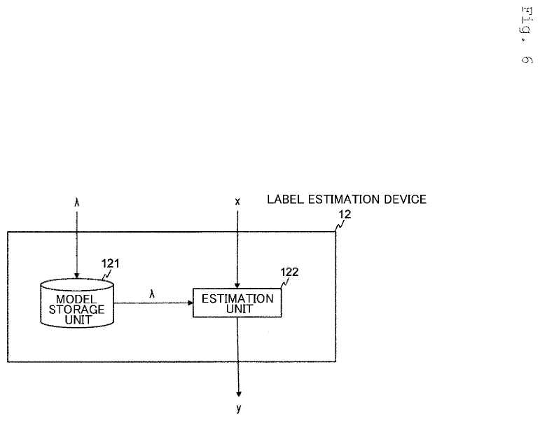

As exemplified in FIG. 1, a model learning device 1 according to the present embodiment includes a learning label data storage unit 111, a learning feature data storage unit 112, an ability data storage unit 113, an evaluation label estimation unit 114, an observation label estimation unit 115, an error evaluation unit 116, an ability learning unit 117, an estimation model learning unit 118, and a control unit 119. Here, the ability data storage unit 113, the evaluation label estimation unit 114, the observation label estimation unit 115, the error evaluation unit 116, the ability learning unit 117, the estimation model learning unit 118, and the control unit 119 correspond to an updating unit. As exemplified in FIG. 6, a label estimation device 12 according to the present embodiment includes a model storage unit 131 and an estimation unit 122.

<Preprocessing>

As preprocessing of model learning processing performed by the model learning device 11, the following three processes are performed. As the first process, learning label data is stored in the learning label data storage unit 111. As the second process, learning feature data is stored in the learning feature data storage unit 112. As the third process, ability data is stored in the ability data storage unit 113. The learning label data includes label data that indicates the values of labels respectively given by a plurality of evaluators to each of a plurality of pieces of learning feature data (label data indicating labels respectively given by the evaluators to the learning feature data). “Label” refers to a correct label that is given to learning feature data by an evaluator who has perceived “information perceptible by human (such as, for example, voices, music, texts, images, and videos)” that corresponds to the learning feature data at the discretion of the evaluator. The value of a label may be a numerical value or a symbol such as an alphabet character. For example, a label is a numerical value indicating an evaluation result given by an evaluator who has perceived “information perceptible by human” that corresponds to learning feature data evaluating the information (for example, a numerical value indicating an impression). Learning feature data refers to feature data for use in learning. Feature data may be data that indicates information perceptible by human (such as, for example, voice data, music data, text data, image data, and video data). Feature data may also be data that indicates features of such information perceptible by human (for example, data regarding the feature amount). Ability data refers to data that indicates the probability that each of a plurality of evaluators gives a correct label to feature data, and the probability that each of the plurality of evaluators gives a wrong label thereto. For example, ability data may be a set of numerical values or symbols such as alphabet characters, or may be a function such as a probability density function.

### Examples of Learning Label Data, Learning Feature Data, and Ability Data

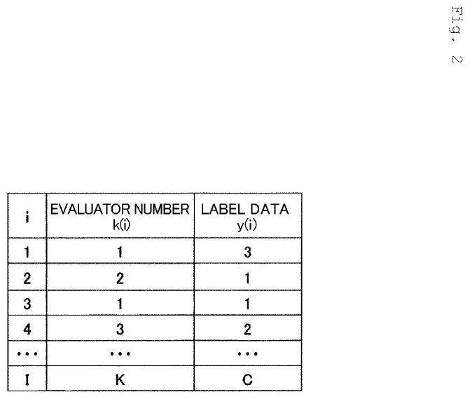

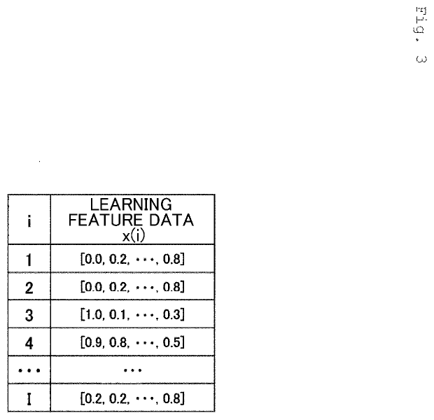

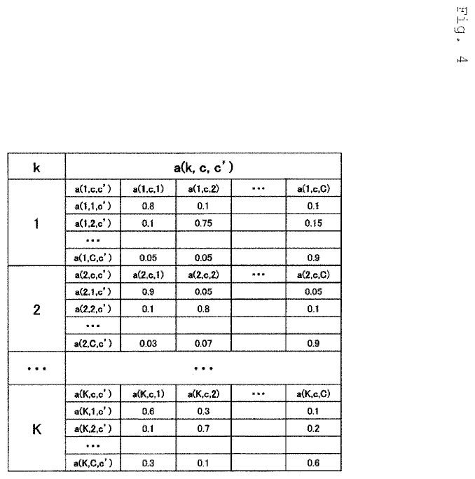

FIG. 2 shows an example of learning label data, FIG. 3 shows an example of learning feature data, and FIG. 4 shows an example of ability data. Note, however, that these are examples and do not intend to restrict the present invention.

### Example of Learning Label Data

Learning label data exemplified in FIG. 2 contains a label data number i, an evaluator number k(i), and label data y(i). The evaluator number k(i) and the label data y(i) are associated with the label data number i. Here, the label data number i∈{1, . . . , I} is a number that identifies a pair of each piece of learning feature data and an evaluator who has given a label thereto (that is, a pair of each piece of learning feature data and an evaluator who has evaluated the data). There may be a case where one evaluator gives a label to one piece of learning feature data, or a case where a plurality of evaluators respectively give labels to the same learning feature data. If different evaluators are provided for the same learning feature data, there are different label data numbers i for the pairs thereof. I is an integer of 2 or more. The evaluator number k(i)∈{1, . . . , K} is a number that identifies each of the plurality of evaluators, and each evaluator number k(i) corresponds to an evaluator in one-to-one correspondence. K is an integer of 2 or more. The label data y(i)∈{1, . . . , C} indicates the label given to learning feature data x(i) corresponding to the label data number i by the evaluator corresponding to the label data number i. C is an integer of 2 or more.

### Example of Learning Feature Data

The pieces of learning feature data x(i) corresponding to the label data number i∈{1, . . . , I} that are exemplified in FIG. 3 are each associated with the corresponding label data number i∈{1, . . . , I}. The learning feature data x(i) exemplified in FIG. 3 is, for example, a feature amount such as a vector that has a voice signal or a feature extracted from the voice signal as an element. As described above, there is a case where two or more evaluators respectively give labels to the same learning feature data, and in such a case, exactly the same learning feature data is identified with label data numbers i that are different from each other. For example, x(1) and x(2) in FIG. 3 are exactly the same learning feature data in terms of content, but two evaluators corresponding to the evaluator numbers k(1) and k(2), which are different from each other, respectively give labels, and thus are identified with different label data numbers i=1, 2.

### Example of Ability Data

Ability data a(k, c, c′) exemplified in FIG. 4 indicates the probability that the evaluator of the evaluator number k∈{1, . . . , K} gives, to the feature data with the label indicated by label data c∈{1, . . . , C}, the label indicated by label data c′∈{1, . . . , C}. In other words, the ability data a(k, c, c′) indicates the probability that, when the evaluator corresponding to the evaluator number k evaluates the feature data with the label indicated by the label data c, the evaluator gives the label indicated by the label data c′∈{1, . . . , C}. That is to say, the label data c indicates the correct label of the feature data. The label data c′ indicates the label given to the feature data by an evaluator. In a case of c=c′, the ability data a (k, c, c′) indicates the probability that the evaluator corresponding to the evaluator number k(i) gives the correct label indicated by the label data c. In a case of c≠c′, the ability data a(k, c, c′) indicates the probability that the evaluator corresponding to the evaluator number k(i) gives a wrong label indicated by the label data c′. In the example shown in FIG. 4, ability data a(k, c, c′) with respect to a pair of label data c∈{1, . . . , C} and label data c′∈{1, . . . , C} is associated with each evaluator number k∈{1, . . . , K}. The ability data a(k, c, c′) of the example shown in FIG. 4 is normalized in a range from 0 to 1 inclusive so that a(k, c, 1)+ . . . +a(k, c, C) is equal to 1.

The default values of the ability data a(k, c, c′) may be set randomly, or a test is conducted as to whether or not each evaluator can give a correct label to feature data, and the default values may be set based on the result thereof. For example, it is assumed that, in the test, a plurality of evaluators evaluate the same feature data and respectively give labels to the feature data. At this time, the label given by another evaluator who has evaluated the same feature data is regarded as a correct label, and thereby the default values of the ability data a (k, c, c′) may be set. For example, out of pieces of feature data to which the label corresponding to the label data c, the set of data of label data numbers i to which labels are given by the evaluators corresponding to the evaluator numbers k(i)≠k′, which are other than the evaluator number k′∈{1, . . . , K}, is expressed by

A_{c.\k′}={i|y(i)=cΛk(i)≠k′}

Also, out of pieces of the same feature data as

A_{c.\k′}={i|y(i)=cΛk(i)≠k′},

the set of data of label data numbers i to which the labels corresponding to the label data c′ are given by the evaluator corresponding to the evaluator number k(i)=k′ who has evaluated the feature data is expressed by

B_{c′.\k′}={i|x(i)∈X_{A}_{_{c.\k′}}Λy(i)=c′Λk(i)=k′}

At this time, the default values of the ability data a(k, c, c′) may be set as follows:

$$a ( {k}^{′} , c , {c}^{′} ) = \frac{\vert {B}_{{c}^{′} , ∖ {k}^{′}} \vert}{\vert {A}_{c , ∖ {k}^{′}} \vert}$$

where |⋅| denotes the number of elements of the set “⋅”, and
\k′denotes a symbol other than k′.

<Model Learning Processing>

The following will describe model learning processing according to the present embodiment.

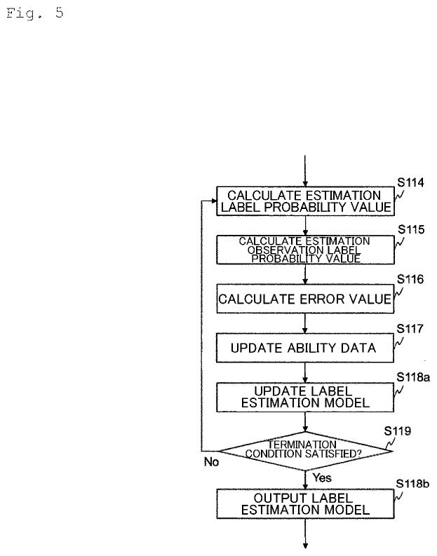

In the model learning processing of the present embodiment, the updating unit receives an input of learning data that contains: the learning feature data x(i); and the label data y(i) that indicates a label given to the learning feature data by an evaluator. Then, in the model learning processing, updated ability data and updated label estimation model λ are obtained in accordance with the guideline described below. The updating unit first evaluates an error value L(i) that indicates an error of an estimation observation label probability value y\hat{ }(i, c′), which is a weighted sum of estimation label probability values h(i, c) with the ability data a (k, c, c′), with respect to the label indicated by the label data y(i). Here, the estimation label probability values h(i, c) are obtained by applying the label estimation model λ, which estimates the probability distribution of labels given to feature data, to the learning feature data x(i) serving as the feature data. The ability data a(k, c, c′) indicates the probability that an evaluator gives a correct label to the feature data and the probability that the evaluator gives a wrong label. Then, the ability data a(k, c, c′) and the label estimation model λ are updated so that the error value L(i) is reduced. Hereinafter, the model learning processing will be described in detail with reference to FIG. 5.

<<Processing of Evaluation Label Estimation Unit 114 (Step S114)>

The evaluation label estimation unit 114 receives inputs of the label estimation model λ output from the estimation model learning unit 118, and the learning feature data x(i) extracted from the learning feature data storage unit 112. Note that examples of the label estimation model λ include a neural network, a hidden Markov model, and a support vector machine. Any default value of the label estimation model λ may be set. The evaluation label estimation unit 114 applies the label estimation model λ to the learning feature data x(i) to obtain and output estimation label probability values h(i, c) (where i∈{1, . . . , I} and c∈{1, . . . , C}). Here, the estimation label probability values h(i, c) indicate the probability that the label data of the correct label of the learning feature data x(i) corresponding to the label data number i is c. That is, the estimation label probability values h(i, c) exemplified in the present embodiment are the probability distribution p(c|x(i), λ) obtained by applying the label estimation model λ to the learning feature data x(i). However, the following expression

$${\sum }_{c ∈ \{ 1 , … , C \}} h ( i , c ) = 1$$

should be satisfied. p(c|x(i),λ) is the probability distribution in which label data of the correct label corresponding to the learning feature data x(i) is c∈{1, . . . , C} in the label estimation model λ.

<<Processing of Observation Label Estimation Unit 115 (Step S115)>>

The observation label estimation unit 115 receives inputs of the estimation label probability values h(i, c) obtained in step S114, the evaluator number k(i) extracted from the learning label data storage unit 111, and the ability data a(k, c, c′) extracted from the ability data storage unit 113. The observation label estimation unit 115 obtains an estimation observation label probability value y\hat{ }(i, c′) based on the input estimation label probability values h(i, c), the evaluator number k(i), and the ability data a(k, c, c′), and outputs the obtained estimation observation label probability value y\hat{ }(i, c′). As described above, the estimation observation label probability value y\hat{ }(i, c′) is a weighted sum of the estimation label probability values h(i, c) with the ability data a(k(i), c, c′). With this, a situation in which an evaluation value deflects from the true value depending on the evaluator's ability is reproduced. As described above, the ability data a(k(i), c, c′) indicates, when the evaluator corresponding to the evaluator number k(i) evaluates the feature data of the label indicated by the label data c, the probability that the label indicated by the label data c′∈{1, . . . , C} is given. The estimation observation label probability value y\hat{ }(i, c′) reproduces the probability that the label corresponding to the label data c′ is given to the learning feature data x(i), based on both the probability (probability of c=c′) that the evaluator corresponding to the evaluator number k(i) gives the correct label, and the probability (probability of c≠c′) that the evaluator gives a wrong label. For example, the observation label estimation unit 115 obtains the estimation observation label probability value y\hat{ }(i, c′) in the following manner, and outputs the obtained estimation observation label probability value y\hat{ }(i, c′).

$$\hat{y} ( i , {c}^{′} ) = {\sum }_{c ∈ \{ 1 , 2 , ⋯ , C \}} a ( k ( i ) , c , {c}^{′} ) h ( i , c )$$

Note that as indicated by the expression, the upper right index “\hat{ }” of “y\hat{ }(i, c′)” should essentially be added to the position immediately above “y”, but there may be cases where it is added to the position to the upper right of “y”, due to restricted description notation.

<<Processing of Error Evaluation Unit 116 (Step S116)>>

The error evaluation unit 116 receives inputs of the estimation observation label probability value y\hat{ }(i, c′) obtained by the observation label estimation unit 115, and the label data y(i) extracted from the learning label data storage unit 111. The error evaluation unit 116 obtains an error value L(i) that indicates an error of the estimation observation label probability value y\hat{ }(i, c′) with respect to the label indicated by the label data y(i), and outputs the obtained error value L(i). The error value L(i) indicates the deviation of the estimation observation label probability value y\hat{ }(i, c′) with respect to the label indicated by the label data y(i). For example, the error evaluation unit 116 evaluates an error between the label data y(i) and the estimation observation label probability value y\hat{ }(i, c′) based on the Categorical Cross-Entropy, which is an error value that is used frequently in class identification, so as to obtain and output the error value L(i). For example, the error evaluation unit 116 obtains the error value L(i) based on the following expression:

$$\begin{matrix}L ( i ) = - {\sum }_{{c}^{′} ∈ \{ 1 , 2 , ⋯ , C \}} Y ( {c}^{′} , i ) log \hat{y} ( i , {c}^{′} ) \\ = - log \hat{y} ( i , y ( i ) )\end{matrix} ,$$

where the following expression is satisfied.

$$Y ( {c}^{′} , i ) = \{ \begin{matrix}1 , & {c}^{′} = y ( i ) \\ 0 , & {c}^{′} \neq y ( i )\end{matrix}$$

<<Processing of Ability Learning Unit 117 (Step S117)>>

The ability learning unit 117 receives inputs of the estimation label probability values h(i, c) obtained in step S114, the estimation observation label probability value y\hat{ }(i, c′) obtained in step S115, the error value L(i) obtained in step S116, the evaluator number k(i) extracted from the learning label data storage unit 111, and the ability data a (k, c, c′) extracted from the ability data storage unit 113. The ability learning unit 117 uses them to update the ability data a(k, c, c′), thereby obtaining the updated ability data a′(k, c, c′). For example, the ability learning unit 117 updates the ability data a(k, c, c′) so that the error value L(i) is reduced, and obtains the updated ability data a(k, c, c′). For example, the ability learning unit 117 first updates a(k, c, c′) with respect to all of c∈{1, . . . , C} as follows.

$$a ( k ( i ) , c , y ( i ) ) ← a ( k ( i ) , c , y ( i ) ) - η \frac{\partial L ( i )}{\partial a ( k ( i ) , c , y ( i ) )} ,$$

where the following expression is satisfied.

$$\frac{\partial L ( i )}{\partial a ( k ( i ) , c , y ( i ) )} = h ( i , c ) \frac{\partial L ( i )}{\partial \hat{y} ( i , y ( i ) )} = - \frac{h ( i , y ( i ) )}{\hat{y} ( i , y ( i ) )}$$

Also, η is a preset parameter of learning rate. r is a positive real number, and if this processing is performed by a neural network, η is 0.01 or smaller, for example. After a(k, c, c′) for all of c∈{1, . . . , C} have been updated in the above-described manner, the ability learning unit 117 performs normalization with respect to, for example, all of c, c″∈{1, . . . , C} in the following manner so that a(k, c, c″) is a probability value, and obtains the updated ability data a(k, c, c″).

$$a ( k ( i ) , c , {c}^{″} ) ← \frac{a ( k ( i ) , c , {c}^{″} )}{{Σ}_{c ′ ∈ \{ 1 , 2 , ⋯ , C \}} a ( k ( i ) , c , {c}^{′} )}$$

The obtained updated ability data a(k, c, c″) is stored as new ability data a(k, c, c″) in the ability data storage unit 113.

<<Processing of Estimation Model Learning Unit 118 (Step S118a)>

The estimation model learning unit 118 receives inputs of the estimation observation label probability value y\hat{ }(i, c′) obtained in step S115, the error value L(i) obtained in step S116, the evaluator number k(i) extracted from the learning label data storage unit 111, and the ability data a(k, c, c′) updated in step S117 and extracted from the ability data storage unit 113. The estimation model learning unit 118 uses them to obtain an updated label estimation model λ obtained by updating the label estimation model λ, and outputs the obtained updated label estimation model λ. For example, the estimation model learning unit 118 updates the label estimation model λ so that the error value L(i) is reduced, and obtains the updated label estimation model λ. For example, the estimation model learning unit 118 updates the parameter of the updated label estimation model λ so that the error value L(i) is reduced, based on the following gradient.

$$\frac{\partial L ( i )}{\partial h ( i , c )} = a ( k ( i ) , c , y ( i ) ) \frac{\partial L ( i )}{\partial \hat{y} ( i , y ( i ) )}$$

If the label estimation model λ is a neural network, the estimation model learning unit 118 updates, based on the above-described gradient, the parameter of the label estimation model λ using a gradient descent method, for example. If the label estimation model λ is a neural network, the estimation model learning unit 118 may obtain a gradient for updating the parameter based on the above-described gradient, and may update the parameter. The updated label estimation model 2. obtained in the above-described manner is transmitted, as a new label estimation model n, to the evaluation label estimation unit 114.

<<Processing of Control Unit 119 (Step S119)>

The control unit 119 determines whether or not a termination condition is satisfied. The termination condition is not limited, but, for example, a case where the amount of change in the parameter of the label estimation model λ between before and after step S118a is a predetermined value or smaller (the parameter of the label estimation model λ has sufficiently converged), a case where update of the parameter of the label estimation model λ is executed a predetermined number of times, or the like can be used as the termination condition. If it is determined that the termination condition is not satisfied, the procedure moves back to step S114. That is, the processing from step S114 onwards is repeated again using the updated ability data updated in step S117 as new ability data a(k, c, c′), and the updated label estimation model updated in step S118a as a new label estimation model λ.

<<Processing of Estimation Model Learning Unit 118 (Step S118b)>>

On the other hand, if it is determined in step S119 that the termination condition is satisfied, the estimation model learning unit 118 outputs the parameter for specifying the label estimation model λ obtained ultimately in step S118a (information for specifying the updated label estimation model λ). Alternatively, the estimation model learning unit 118 may output the parameter for specifying the label estimation model λ before being updated ultimately in step S118a (information for specifying the label estimation model λ).

<Estimation Processing>

The following will describe estimation processing according to the present embodiment.

As described above, the parameter that specifies the label estimation model λ output from the model learning device 11 is stored in the model storage unit 121 of the label estimation device 12 (FIG. 6). The estimation unit 122 receives an input of input feature data x of the same type as the above-described learning feature data x(i). The estimation unit 122 reads information for specifying the label estimation model λ from the model storage unit 121, applies the input feature data x to the label estimation model λ, and estimates and outputs a label y for the input feature data x. For example, the estimation unit 122 may output the label y for the input feature data x. The estimation unit 122 may also output a plurality of labels y and the probabilities thereof. The estimation unit 122 may also output the plurality of labels y in descending order of the probability.

### Second Embodiment

Hereinafter, a second embodiment of the present invention will be described. In the second embodiment, the functions of the updating unit of the first embodiment, which includes the ability data storage unit 113, the evaluation label estimation unit 114, the observation label estimation unit 115, the error evaluation unit 116, the ability learning unit 117, the estimation model learning unit 118, and the control unit 119, are implemented by a single neural network. Hereinafter, differences from the first embodiment are mainly described, and the matters that have been described are given with the same reference numerals, and descriptions thereof are simplified.

<Configuration>

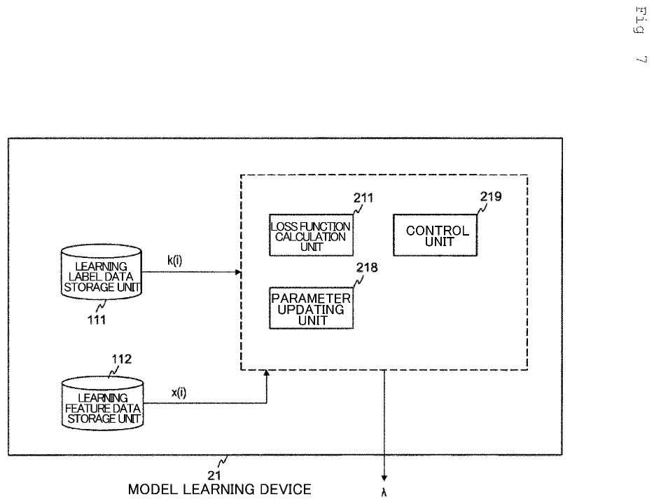

As exemplified in FIG. 7, a model learning device 21 of the present embodiment includes the learning label data storage unit 111, the learning feature data storage unit 112, a loss function calculation unit 211, a parameter updating unit 218, and a control unit 219. Here, the loss function calculation unit 211, the parameter updating unit 218, and the control unit 219 correspond to the updating unit. Also in the second embodiment, the same label estimation device 12 as that in the first embodiment is used.

<Preprocessing>

As preprocessing of model learning processing performed by the model learning device 21, learning label data is stored in the learning label data storage unit 111, and learning feature data is stored in the learning feature data storage unit 112. The difference from the first embodiment is that although ability data is stored in the ability data storage unit 113 in the preprocessing of the first embodiment, this process is omitted in the preprocessing of the present embodiment. Otherwise, this preprocessing is the same as the preprocessing of the first embodiment.

<Model Learning Processing>

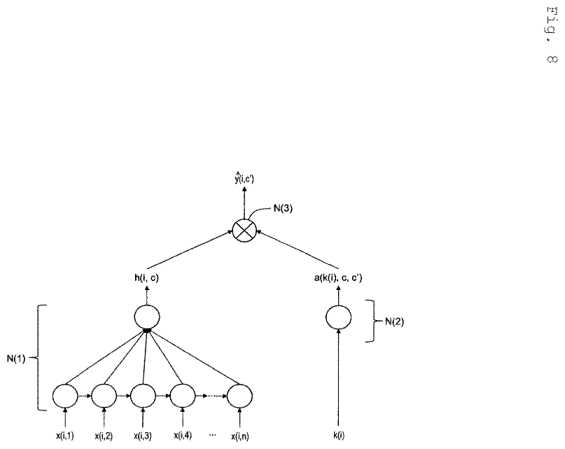

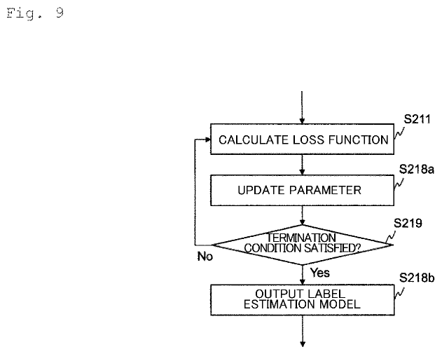

The following will describe model learning processing of the present embodiment with reference to FIGS. 8 and 9.

In the model learning processing of the present embodiment, as will be described below, a label estimation model λ or an updated label estimation model λ that is obtained by performing learning processing using an error value as a loss function until a predetermined termination condition is satisfied is output to a neural network that includes a first node N(1) (one or more nodes), a second node N(2) (one or more nodes), and a third node N(3) (one or more nodes).

Here, the first node N(1) is a normal neural network that functions as the label estimation model λ, and obtains estimation label probability values h(i, c) upon input of learning feature data x(i)=(x(i, 1), . . . , x(i, n)). The second node N(2) performs, upon input of an evaluator number k(i), conversion using an embedding layer or the like, and outputs the obtained ability data a(k(i), c, c′). The third node N(3) performs, upon input of the estimation label probability values h(i, c) and the ability data a(k(i), c, c′), conversion based on probability calculation, and outputs the obtained estimation observation label probability value y\hat{ }(i, c′).

$$\hat{y} ( i , {c}^{′} ) = {\sum }_{c ∈ \{ 1 , 2 , ⋯ , C \}} a ( k ( i ) , c , {c}^{′} ) h ( i , c )$$

Where n is an integer of 1 or more, and k(i)∈{1, . . . , K}, i∈{1, . . . , I}, y(i)∈{1, . . . , C}, c∈{1, . . . , C}, and c′∈{1, . . . , C} are satisfied.

<<Processing of Loss Function Calculation Unit 211 (Step S211)>>

Using the estimation observation label probability value y\hat{ }(i, c′), which is obtained as a result of the learning feature data x(i) extracted from the learning feature data storage unit 112 being input to the first node N(1) and the evaluator number k(i) extracted from the learning label data storage unit 111 being input to the second node N(2) and is output from the third node N(3), and the label data y(i) extracted from the learning label data storage unit 111, the loss function calculation unit 211 obtains an error value L(i) in a manner as described with reference to step S116 of the first embodiment, and outputs the obtained error value L(i) as a loss function L(i).

<<Processing of Parameter Updating Unit 218 (Step S218a)>>

The parameter updating unit 218 receives an input of the loss function L(i) obtained in step S211 and performs learning processing using the loss function L(i), thereby updating parameters (for example, at least one of a weight and an activation function) of the first node N(1) and the second node N(2) of the above-described neural network. For example, the parameter updating unit 218 updates parameters of the first node N(1) and the second node N(2) so that the loss function L(i) is reduced. A back propagation method, a gradient descent method, or the like can be used for the parameter update.

<<Processing of Control Unit 219 (Step S219)>

The control unit 219 determines whether or not a termination condition is satisfied. The termination condition is not limited, but any of, for example, the following four cases falls under the termination condition. The first case is that the amount of change from the estimation observation label probability value y\hat{ }(i, c′) obtained in the step S211 in the previous procedure to the estimation observation label probability value y\hat{ }(i, c′) obtained in the step S211 in the current procedure is a predetermined value or less (a case where the estimation observation label probability value y\hat{ }(i, c′) has sufficiently converged). The second case is that the amount of change from the loss function L(i) obtained in the step S211 in the previous procedure to the loss function L(i) obtained in the step S211 in the current procedure is a predetermined value or less (a case where the loss function L(i) has sufficiently converged). The third case is that the amount of change from the parameter updated in the step S218a in the previous procedure to the parameter updated in the step S218a in the current procedure is a predetermined value or less (a case where the parameter of the label estimation model λ has sufficiently converged). The fourth case is that the parameter update in step S218a has been executed a predetermined number of times, and the like. Any of these cases can be defined as the termination condition. If it is determined that the termination condition is not satisfied, the procedure moves back to step S211, and the processing in steps S211, S218a, and S219 are executed again. On the other hand, if it is determined that the termination condition is satisfied, the parameter updating unit 218 outputs the parameter of the first node N(1) as the parameter of the label estimation model λ.

<<Processing of Parameter Updating Unit 218 (Step S218b)>>

On the other hand, if it is determined in step S219 that the termination condition is satisfied, the parameter updating unit 218 outputs the parameter of the first node N(1) ultimately updated in step S218a as the parameter for specifying the label estimation model λ (information for specifying the updated label estimation model λ). Alternatively, the parameter updating unit 218 may output the parameter of the first node N(1) before being ultimately updated in step S218a as the parameter for specifying the label estimation model λ (information for specifying the label estimation model λ).

<Estimation Processing>

The following will describe estimation processing of the present embodiment. In the first embodiment, the parameter for specifying the label estimation model λ output from the model learning device 11 is stored in the model storage unit 121 of the label estimation device 12 (FIG. 6), but in the second embodiment, the parameter for specifying the label estimation model λ output from the model learning device 21 is stored in the model storage unit 121 of the label estimation device 12. Otherwise, this estimation processing is the same as the estimation processing of the first embodiment.

[Other Modifications and the Like]

Note that the present invention is not limited to the above-described embodiments. For example, the respective pieces of processing of the evaluation label estimation unit 114, the observation label estimation unit 115, the error evaluation unit 116, the ability learning unit 117, the estimation model learning unit 118, and the control unit 119 that have been described in the first embodiment may be executed by a single processing unit. Alternatively, the respective pieces of processing of a plurality of processing units included in the evaluation label estimation unit 114, the observation label estimation unit 115, error evaluation unit 116, the ability learning unit 117, the estimation model learning unit 118, and the control unit 119 may be executed by a single processing unit. In this case, the implementing method is not limited to a neural network. For example, in the second embodiment, the functions of the updating unit that includes the ability data storage unit 113, the evaluation label estimation unit 114, the observation label estimation unit 115, the error evaluation unit 116, the ability learning unit 117, the estimation model learning unit 118, and the control unit 119 are implemented by a single neural network, but may be implemented together by another method.

The above-described various types of processing may be not only executed in time-series manner in accordance with the description, but also executed in parallel or individually according to the throughput of a device that executes the processing or according to the need. Moreover, it is needless to say that changes may be suitably made without departing from the spirit of the present invention.

The above-described devices are configured by, for example, a general-purpose computer or a dedicated computer that includes a processor (hardware processor) such as a CPU (central processing unit) and a memory such as a RAM (random-access memory) or a ROM (read-only memory) executing a predetermined program. This computer may be provided with one processor and one memory, or may be provided with a plurality of processors and a plurality of memories. This program may be installed in the computer or may be recorded in advance in the ROM or the like. Also, some or all of the processing units may be configured using an electronic circuitry that realizes the processing functions without using the program, instead of an electronic circuitry such as a CPU that realizes the functional configuration as a result of the program being read. An electronic circuitry constituting one device may include a plurality of CPUs.

If the above-described configuration is realized by a computer, the processing content of the functions that the devices should have is described in a program. By executing this program by the computer, the processing functions are realized on the computer. The program in which the processing content is described can be recorded on a computer-readable recording medium. Examples of the computer-readable recording medium include a non-transitory recording medium. Examples of such a recording medium include a magnetic recording device, an optical disk, a magnetooptical medium, and a semiconductor memory.

This program is distributed by the sales, transfer, lending, or the like, of a portable recording medium such as a DVD and a CD-ROM in which the program is recorded. Furthermore, the program may also be distributed such that this program is stored in a storage device in a server computer and transferred from the server computer to another computer via a network.

First, the computer that executes such a program once stores the program recorded in a portable recording medium or transferred from the server computer for example, in its own storage device. During the execution of the processing, this computer reads the program stored in its own storage device and executes processing in accordance with the read program. As another aspect of execution of the program, the computer may directly read the program from the portable recording medium and may execute the processing in accordance with this program, and the computer may also execute, upon receiving programs transferred from the server computer, processing sequentially in accordance with the received programs. A configuration is also possible in which the above-described processing is executed not by transferring the programs from the server computer to this computer, but using a so-called ASP (Application Service Provider) service, which realizes processing functions only based on an execution instruction and acquisition of a result.

Instead of the processing functions of the present devices being realized by a predetermined program being executed on a computer, at least some of the processing functions may be realized by hardware.

### REFERENCE SIGNS LIST

11, 21 Model learning device
12 Label estimation device

1. A model learning device comprising:
an updater configured to:
receive an input of learning data that contains learning feature data and label data indicating a label given to the learning feature data by an evaluator;
obtain, based on estimation label probability values obtained by applying a label estimation model, which estimates a probability distribution of labels given to feature data, to the learning feature data serving as the feature data, and ability data, which indicates a probability that an evaluator gives a correct label to the feature data and a probability that the evaluator gives a wrong label to the feature data, an estimation observation label probability value that is a weighted sum of the estimation label probability values with the ability data; and
obtain updated ability data by updating the ability data, and an updated label estimation model by updating the label estimation model, the updated ability data and the updated label estimation model being updated so that an error value is reduced, the error value indicating an error of the estimation observation label probability value with respect to the label indicated by the label data.

2. The model learning device according to claim 1, wherein information for specifying the label estimation model or the updated label estimation model is output, the label estimation model or the updated label estimation model being obtained by repeating processing of the updater using the updated ability data as new ability data and the updated label estimation model as a new label estimation model, until a predetermined termination condition is satisfied.

3. The model learning device according to claim 1,
wherein i∈{1, . . . , I} is a label data number, k(i)∈{1, . . . , K} is an evaluator number, y(i)∈{1, . . . , C}, c∈{1, . . . , C}, and c′∈{1, . . . , C} are the label data, and I, K, and C are integers of 2 or more, the learning data contains:
the learning feature data x(i) that corresponds to the label data number i∈{1, . . . , I}; and the label data y(i) that indicates a label given to the learning feature data x(i) by the evaluator of the evaluator number k(i)∈{1, . . . , K}, the estimation label probability values h(i, c) are a probability distribution p(c|x(i), X) obtained by applying the label estimation model λ to the learning feature data x(i), the ability data a(k, c, c′) indicates a probability that the evaluator of the evaluator number k(i) gives, to the feature data of a label indicated by the label data c, a label indicated by the label data c′, and the estimation observation label probability value y\hat{ }(i, c′) is given by
$$\hat{y} ( i , {c}^{′} ) = {\sum }_{c ∈ \{ 1 , 2 , ⋯ , C \}} a ( k ( i ) , c , {c}^{′} ) h ( i , c ) .$$

4. The model learning device according to claim 1,
wherein i∈{1, . . . , I} is a label data number, k(i)∈{1, . . . , K} is an evaluator number, y(i)∈{1, . . . , C}, c∈{1, . . . , C}, and c′∈{1, . . . , C} are the label data, and I, K, and C are integers of 2 or more, the learning data contains:
the learning feature data x(i) that corresponds to the label data number i∈{1, . . . , I}; and
the label data y(i) that indicates a label given to the learning feature data x(i) by the evaluator of the evaluator number k(i)∈{1, . . . , K}, the estimation label probability values h(i, c) are a probability distribution p(c|x(i), λ) obtained by applying the label estimation model λ to the learning feature data x(i), the ability data a(k, c, c′) indicates a probability that the evaluator of the evaluator number k(i) gives, to the feature data of a label indicated by the label data c, a label indicated by the label data c′, and the updater outputs information for specifying the label estimation model λ or the updated label estimation model λ to a neural network including:
a first node that functions as the label estimation model λ configured to obtain the estimation label probability values h(i, c) upon input of the learning feature data x(i);
a second node configured to output the ability data a(k(i), c, c′) upon input of the evaluator number k(i); and
a third node configured to perform, upon input of the estimation label probability values h(i, c) and the ability data a(k(i), c, c′), conversion based on probability calculation and output the estimation observation label probability value y\hat{ }(i, c′) given by
$$\hat{y} ( i , {c}^{′} ) = {\sum }_{c ∈ \{ 1 , 2 , ⋯ , C \}} a ( k ( i ) , c , {c}^{′} ) h ( i , c ) ,$$
the information for specifying the label estimation model λ or the updated label estimation model λ being obtained by performing learning processing using the error value as a loss function until a predetermined termination condition is satisfied, the error value being obtained using the estimation observation label probability value y\hat{ }(i, c′) output from the third node and the label data y(i).

5. (canceled)

6. A model learning method comprising:
receiving, by an updater, an input of learning data that contains learning feature data and label data indicating a label given to the learning feature data by an evaluator;
obtaining, by an updater based on estimation label probability values obtained by applying a label estimation model, which estimates a probability distribution of labels given to feature data, to the learning feature data serving as the feature data, and ability data, which indicates a probability that an evaluator gives a correct label to the feature data and a probability that the evaluator gives a wrong label to the feature data, an estimation observation label probability value that is a weighted sum of the estimation label probability values with the ability data; and
obtaining, by an updater, updated ability data by updating the ability data, and an updated label estimation model by updating the label estimation model, the updated ability data and the updated label estimation model being updated so that an error value is reduced, the error value indicating an error of the estimation observation label probability value with respect to the label indicated by the label data.

7. A label estimation method comprising:
receiving input feature data;
applying the input feature data to a label estimation model output from an updater associated with ability data; and
estimating, by the label estimator, a label to be given to the input feature data.

8-9. (canceled)

10. The model learning device according to claim 2,
wherein i∈{1, . . . , I} is a label data number, k(i)∈{1, . . . , K} is an evaluator number, y(i)∈{1, . . . , C}, c∈{1, . . . , C}, and c′∈{1, . . . , C} are the label data, and I, K, and C are integers of 2 or more, the learning data contains:
the learning feature data x(i) that corresponds to the label data number i∈{1, . . . , I}; and the label data y(i) that indicates a label given to the learning feature data x(i) by the evaluator of the evaluator number k(i)∈{1, . . . , K}, the estimation label probability values h(i, c) are a probability distribution p(c|x(i), λ) obtained by applying the label estimation model λ to the learning feature data x(i), the ability data a(k, c, c′) indicates a probability that the evaluator of the evaluator number k(i) gives, to the feature data of a label indicated by the label data c, a label indicated by the label data c′, and the estimation observation label probability value y\hat{ }(i, c′) is given by
$$\hat{y} ( i , {c}^{′} ) = {\sum }_{c ∈ \{ 1 , 2 , ⋯ , C \}} a ( k ( i ) , c , {c}^{′} ) h ( i , c ) .$$

11. The model learning method according to claim 6,
wherein information for specifying the label estimation model or the updated label estimation model is output, the label estimation model or the updated label estimation model being obtained by repeating processing of the updater using the updated ability data as new ability data and the updated label estimation model as a new label estimation model, until a predetermined termination condition is satisfied.

12. The model learning method according to claim 6,
wherein i∈{1, . . . , I} is a label data number, k(i)∈{1, . . . , K} is an evaluator number, y(i)∈{1, . . . , C}, c∈{1, . . . , C}, and c′∈{1, . . . , C} are the label data, and I, K, and C are integers of 2 or more, the learning data contains:
the learning feature data x(i) that corresponds to the label data number i∈{1, . . . , I}; and the label data y(i) that indicates a label given to the learning feature data x(i) by the evaluator of the evaluator number k(i)∈{1, . . . , K}, the estimation label probability values h(i, c) are a probability distribution p(c|x(i), λ) obtained by applying the label estimation model λ to the learning feature data x(i), the ability data a(k, c, c′) indicates a probability that the evaluator of the evaluator number k(i) gives, to the feature data of a label indicated by the label data c, a label indicated by the label data c′, and the estimation observation label probability value y\hat{ }(i, c′) is given by
$$\hat{y} ( i , {c}^{′} ) = {\sum }_{c ∈ \{ 1 , 2 , ⋯ , C \}} a ( k ( i ) , c , {c}^{′} ) h ( i , c ) .$$

13. The model learning method according to claim 6,
wherein i∈{1, . . . , I} is a label data number, k(i)∈{1, . . . , K} is an evaluator number, y(i)∈{1, . . . , C}, c∈{1, . . . , C}, and c′∈{1, . . . , C} are the label data, and I, K, and C are integers of 2 or more, the learning data contains:
the learning feature data x(i) that corresponds to the label data number i∈{1, . . . , I}; and
the label data y(i) that indicates a label given to the learning feature data x(i) by the evaluator of the evaluator number k(i)∈{1, . . . , K}, the estimation label probability values h(i, c) are a probability distribution p(c|x(i), λ) obtained by applying the label estimation model λ to the learning feature data x(i), the ability data a(k, c, c′) indicates a probability that the evaluator of the evaluator number k(i) gives, to the feature data of a label indicated by the label data c, a label indicated by the label data c′, and the updater outputs information for specifying the label estimation model λ or the updated label estimation model λ to a neural network including:
a first node that functions as the label estimation model λ configured to obtain the estimation label probability values h(i, c) upon input of the learning feature data x(i);
a second node configured to output the ability data a(k(i), c, c′) upon input of the evaluator number k(i); and
a third node configured to perform, upon input of the estimation label probability values h(i, c) and the ability data a(k(i), c, c′), conversion based on probability calculation and output the estimation observation label probability value y\hat{ }(i, c′) given by
$$\hat{y} ( i , {c}^{′} ) = {\sum }_{c ∈ \{ 1 , 2 , ⋯ , C \}} a ( k ( i ) , c , {c}^{′} ) h ( i , c ) ,$$
the information for specifying the label estimation model a or the updated label estimation model λ being obtained by performing learning processing using the error value as a loss function until a predetermined termination condition is satisfied, the error value being obtained using the estimation observation label probability value y\hat{ }(i, c′) output from the third node and the label data y(i).

14. The model learning method according to claim 11,
wherein i∈{1, . . . , I} is a label data number, k(i)∈{1, . . . , K} is an evaluator number, y(i)∈{1, . . . , C}, c∈{1, . . . , C}, and c′∈{1, . . . , C} are the label data, and I, K, and C are integers of 2 or more, the learning data contains:
the learning feature data x(i) that corresponds to the label data number i∈{1, . . . , I}; and the label data y(i) that indicates a label given to the learning feature data x(i) by the evaluator of the evaluator number k(i)∈{1, . . . , K}, the estimation label probability values h(i, c) are a probability distribution p(c|x(i), λ) obtained by applying the label estimation model λ to the learning feature data x(i), the ability data a(k, c, c′) indicates a probability that the evaluator of the evaluator number k(i) gives, to the feature data of a label indicated by the label data c, a label indicated by the label data c′, and the estimation observation label probability value y\hat{ }(i, c′) is given by
$$\hat{y} ( i , {c}^{′} ) = {\sum }_{c ∈ \{ 1 , 2 , ⋯ , C \}} a ( k ( i ) , c , {c}^{′} ) h ( i , c ) .$$

15. The label estimation method according to claim 7,
wherein the updater:
receives an input of learning data that contains learning feature data and label data indicating a label given to the learning feature data by an evaluator;
obtains, based on estimation label probability values obtained by applying a label estimation model, which estimates a probability distribution of labels given to feature data, to the learning feature data serving as the feature data, and ability data, which indicates a probability that an evaluator gives a correct label to the feature data and a probability that the evaluator gives a wrong label to the feature data, an estimation observation label probability value that is a weighted sum of the estimation label probability values with the ability data; and
obtains, by an updater, updated ability data by updating the ability data, and an updated label estimation model by updating the label estimation model, the updated ability data and the updated label estimation model being updated so that an error value is reduced, the error value indicating an error of the estimation observation label probability value with respect to the label indicated by the label data.
